(19) United States
(12) Patent Application Publication
(10) Pub. No.: US 2017/0091849 A1
(43) Pub. Date: Mar. 30, 2017

(54) Personalized Channel

(71) Applicant: LF Technology Development Corporation Limited, London (GB)

(72) Inventors: Alexander Greystoke, Lakeway, TX (US); Shy Blick, Austin, TX (US)

(73) Assignee: LF Technology Development Corporation Limited, London (GB)

(21) Appl. No.: 15/230,346

(22) Filed: Aug. 5, 2016

Related U.S. Application Data
(63) Continuation-in-part of application No. 14/793,618, filed on Jul. 7, 2015.
Application No. 14/793,618 is a continuation-in-part of application No. 14/327,543, filed on Jul. 9, 2014.
Application No. 14/327,543 is a continuation-in-part of application No. 14/169,058, filed on Jan. 30, 2014.
Application No. 14/169,058 is a continuation-in-part of application No. 14/169,060, filed on Jan. 30, 2014.
Application No. 14/169,060 is a continuation-in-part of application No. 14/603,227, filed on Jan. 22, 2015.
Application No. 14/603,227 is a continuation-in-part of application No. 14/640,865, filed on Mar. 6, 2015.
Application No. 14/640,865 is a continuation-in-part of application No. 14/738,881, filed on Jun. 13, 2015.
(60) Provisional application No. 62/201,573, filed on Aug. 5, 2015.
(60) Provisional application No. 61/759,314, filed on Jan. 31, 2013.
(60) Provisional application No. 61/759,317, filed on Jan. 31, 2013.
(60) Provisional application No. 61/844,355, filed on Jul. 9, 2013.
(60) Provisional application No. 61/844,353, filed on Jul. 9, 2013.
(60) Provisional application No. 61/844,350, filed on Jul. 9, 2013.
(60) Provisional application No. 62/011,574, filed on Jun. 13, 2014.

(51) Int. Cl. G06Q 30/06; G06F 17/30

(52) U.S. Cl. CPC G06Q 30/0631; G06F 17/30991; G06F 17/30864; G06Q 50/01

(57) ABSTRACT

In certain embodiments, a decision system may allow a user to define a personalized channel based on the user's interests and including associated information. The decision system may subsequently use the personalized channel to determine and present options to the user. In certain embodiments, the decision system may allow the user to share his or her personalized channel with other users and may reward the user when his or her personalized channel is used. Further, the decision system may recommend options for addition to the user's channel.

### CROSS-REFERENCE TO RELATED APPLICATION(S)

The present application is a non-provisional of and claims priority to U.S. Provisional Application No. 62/201,573 filed on Aug. 5, 2015 and entitled “Personalized Channel”, which is incorporated herein by reference in its entirety. Further, the present application is a continuation-in-part of and claims priority to U.S. patent application Ser. No. 14/793,618, filed on Jul. 7, 2015 and entitled “Systems and Methods of Providing Outcomes Based on Collective Intelligence Experience”, which is a continuation-in-part of and claims priority to U.S. patent application Ser. No. 14/327,543, filed on Jul. 9, 2014, and entitled “Computer-Aided Decision Systems,” which is a continuation-in-part of and claims priority to U.S. patent application Ser. No. 14/169,058, filed on Jan. 20, 2014, entitled “VIRTUAL PURCHASING ASSISTANT”, which claimed priority to U.S. Provisional Patent Application No. 61/759,314, filed on Jan. 21, 2013, and entitled “VIRTUAL PURCHASING ASSISTANT”; and is also a continuation-in-part of and claims priority to U.S. patent application Ser. No. 14/169,060 filed on Jan. 20, 2014, entitled “DUAL PUSH SALES OF TIME SENSITIVE INVENTORY”, which claimed priority to U.S. Provisional Patent Application No. 61/759,317, filed on Jan. 21, 2013, and entitled “DUAL PUSH SALES OF TIME SENSITIVE INVENTORY”; and is also a non-provisional of and claims priority to U.S. Provisional Patent Application No. 61/844,355, filed on Jul. 9, 2013, entitled “INVENTORY SEARCHING WITH AN INTELLIGENT RECOMMENDATION ENGINE”; is also a non-provisional of and claims priority to U.S. Provisional Patent Application No. 61/844,353, filed on Jul. 9, 2013, entitled “SINGLE PAGE TRAVEL SEARCH AND RESULTS MODIFICATION”; and is also a non-provisional of and claims priority to U.S. Provisional Patent Application No. 61/844,350, filed on Jul. 9, 2013, entitled “SEARCHING FOR INVENTORY USING AN ARTIFICIAL INTELLIGENCE PRIORITIZATION ENGINE”; and is also a continuation-in-part of and claims priority to U.S. patent application Ser. No. 14/603,227 filed on Jan. 22, 2015, entitled “INTELLIGENT PROPERTY RENTAL SYSTEM”; and is also a continuation-in-part of and claims priority to U.S. patent application Ser. No. 14/640,865 filed on Mar. 6, 2015, entitled “PURCHASING FEEDBACK SYSTEM”; and is also a continuation-in-part of and claims priority to U.S. patent application Ser. No. 14/738,881 filed on Jun. 13, 2015, entitled “SYSTEMS AND METHODS FOR A LEARNING DECISION SYSTEM WITH A GRAPHICAL SEARCH INTERFACE”; and is also a non-provisional of and claims priority to U.S. Provisional Patent Application No. 62/011,574, filed on Jun. 13, 2014, entitled “PERSONA-BASED PURCHASING ASSISTANTS”, the contents of all of which are hereby incorporated by reference in their entireties.

### FIELD

The present disclosure is generally related to the field of computer-aided decision-making systems. More particularly, the present disclosure generally relates to decision systems and methods that allow a user to configure a personalized channel that may be customized to include activities (e.g., tours), places to stay, car rentals, other interests, or any combination thereof.

### BACKGROUND

Websites sometimes allow individuals to post their thoughts and preferences about various matters for others to view and share. Some websites allow users to share music, reviews, and other data. Further, other websites may allow a user to store a set of links to other websites.

### SUMMARY

In certain embodiments, a computer-aided decision system may allow a user or users to define a personalized channel (such as a hotel channel, an activity channel, an interest channel, a rental car channel, and so on) based on his or her interests and associated information. The decision system may subsequently use data determined from the personalized channel to prioritize and filter potential outcomes corresponding to the constraints defined by the personalized channel. In certain embodiments, the decision system may allow the user to share his or her personalized channel with other users and may reward the user when his or her personalized channel is used. The decision system may suggest additional options for the personalized channel and may adjust suggestions based on feedback from the user (explicit or implicit), making the channel smarter. The user may also view personalized channels of other users, add content from other channels, look for similarities between a first channel and a second channel, rent or sell the personalized channel to other users, and so on. In certain embodiments, the decision system may allow the user to build customized promotions around his/her personalized channel.

In certain embodiments, a user or users may create a hotel channel, which may include his or her favorite hotels; car channel including the user's favorite cars; a vacation rental channel; an activities channel, including for example the Graceland private tour and a Beatles tour of Liverpool, England; a make my own record channel; and so on. In certain embodiments, the decision system may analyze the content of the user's channel, review other activities of the user, review social media, examine collective information, search available inventory, and recommend other options for inclusion in the user's channel. Further, the decision system may enable the user to share his or her channel with other users, to allow a user to rent or sell his or her channel, to borrow from other users, and so on.

In some embodiments, a decision system may include an interface configured to couple to a network, a processor coupled to the interface, and a memory coupled to the processor. The memory may be configured to store instructions that, when executed, cause the processor to receive data indicating interests of a user and create a personalized channel associated with the user based on the received data. The memory may further include instructions that, when executed, cause the processor to utilize data from the personalized channel to identify one or more options corresponding to preferences determined from the personalized channel, in response to a user request, and to provide an interface including the one or more options to a device associated with the user. In a particular aspect, the memory may further include instructions that, when executed, cause the processor to selectively share the personalized channel with one or more other users based on a preference specified by the user.

In other embodiments, a method can include receiving data at a decision system through a network from a computing device. The data may define a personalized channel associated with a user. The method may further include storing the personalized channel in a database including a plurality of personalized channels and automatically determining values and attributes associated with content of the personalized channel using the decision system. The method may also include determining one or more options of interest to the user based on the determined values and attributes using the decision system and selectively adding data related to the one or more options to the personalized channel.

In still another embodiment, a decision system may include an interface configured to couple to a network, a processor coupled to the interface, and a memory coupled to the processor. The memory may be configured to store instructions that, when executed, cause the processor to receive a user request indicating an item of interest for a user and retrieve a personalized channel associated with the user from a database including a plurality of personalized channels. The instructions may also cause the processor to determine a plurality of purchase options based on the user request, prioritize the plurality of purchase options based on preferences determined from the personalized channel, and provide an interface including data related to at least one of the plurality of purchase options to a device associated with the user.

### BRIEF DESCRIPTION OF THE DRAWINGS

FIG. 1 depicts a block diagram of a decision system including a personalized channel feature, in accordance with certain embodiments of the present disclosure.

FIG. 2 depicts a block diagram of a decision system including a personalized channel feature, in accordance with certain embodiments of the present disclosure.

FIG. 3 illustrates a block diagram of the decision system of FIG. 2, and including an example of some channels owned by a particular user, in accordance with certain embodiments of the present disclosure.

FIG. 4 illustrates a flow diagram of a method of creating a personalized channel, in accordance with certain embodiments of the present disclosure.

FIG. 5 depicts a flow diagram of a method of using a personalized channel, in accordance with certain embodiments of the present disclosure.

FIG. 6 depicts a flow diagram of a method of using a personalized channel, in accordance with certain embodiments of the present disclosure.

FIG. 7 depicts a flow diagram of a method of allowing another user to use a personalized channel, in accordance with certain embodiments of the present disclosure.

FIG. 8 illustrates a graphical interface accessible to configure, manage, and use one or more personalized channels, in accordance with certain embodiments of the present disclosure.

FIG. 9 depicts a graphical interface accessible to configure, manage, and use one or more personalized channels, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of the embodiments, reference is made to the accompanying drawings which form a part hereof, and which are shown by way of examples. The features of the various embodiments and examples described herein may be combined, exchanged, removed, other embodiments utilized, and structural changes made without departing from the scope of the present disclosure.

One or more aspects or features of the subject matter described herein can be implemented in digital electronic circuitry, integrated circuitry, application specific integrated circuits (ASICs), field programmable gate arrays (FPGAs), another dedicated hardware implementation, computer hardware, firmware, software, or any combination thereof. In accordance with various embodiments, the methods and functions described herein may be implemented as one or more software programs executable by a computer processor of a computing device, such as a laptop computer, a server, a desktop computer, or a handheld computing device, such as a tablet computer, a personal digital assistant (PDA), or smart phone. Further, in some embodiments, the methods and functions described herein may be implemented as a device, such as a non-volatile computer readable storage device or memory device, including instructions that, when executed, cause a processor to perform the methods and functions. As used herein, a digital persona, such as a persona in the digital personas 138, can be a digital representation of an entity (a human, corporation, group, etc.). A digital persona can be a digital representation of a virtual being or a real being that has a set of preferences or rules in relation to a certain problem. An entity may be a depiction of a virtual or real being that has a set of preferences, weights or tendencies in relation to a certain problem. A potential solution may be a solution to a problem that may or may not relate to the priorities of a corresponding digital persona. In certain embodiments, a potential solution may represent a potential option that may be selected to satisfy one or more of the digital persona's needs or solve their problem. A chosen or selected solution can be at least one of the potential solutions that, by way of weighing, was chosen to be appropriate (or most appropriate) to solve the problem or that was determined, based on scoring, to be the most satisfactory to the digital persona.

An engine can be a software mechanism that can process several tasks: such as reading digital persona preferences; obtaining a list of potential solutions; combining competing personas into a unified persona; selecting between competing personas to identify a subset of possible solutions; and determining optimal solutions with respect to specific situations. Priority can be a way to show a preference in relation to other preferences so as to allow the engine to weigh an impact of a preference on the overall score. An entity may be a human, corporation, or group that may have preferences with respect to a certain problem, a set of products, a scenario, a situation, or any combination thereof. An entity may either be virtual or real. The entity may represent a virtual entity, a person, a certain facet of a person (e.g., the user as a business person vs. the user as a family person), or a surrogate (e.g. an entity acting on behalf of an employer, a parent for a child, a guardian in a custodial relationship, a trustee on behalf of a beneficiary). A parameter may be a specific set of rules, preferences, and priorities established by a user of a digital persona with respect to a defined situation or opportunity to decide among varied options.

Embodiments of a decision system may be configured to create one or more personalized channels based on one or more selected interests of a user. In an example, the user may create a channel (such as a hotel channel. an activities channel, a vacation rental channel, another type channel, or any combination thereof) and may configure the channel based on his or her interests. In certain embodiments, a channel can include data corresponding to numerous related or unrelated items. In some embodiments, a user may choose to create a channel related to a particular category of interest. Alternatively, the user may create a channel to which he or she adds various unrelated items or links, and may add categories within the particular channel in order to organize the information. In some embodiments, the system may be configured to automatically create a new channel on behalf of the user, where content of the new channel can often be determined based on data determined from the user's other channels in other subject areas.

Each channel may be associated with an account of a user. The user's account may include an account name, the account type, and other information. Further, the user's account may include one or more indicators linking the account to a corresponding one or more personalized channels. Each channel may be configured to include links, text, images, videos, or other information uploaded by the user. The user may customize the background, color scheme, arrangement, categories, and other parameters of each of his or her channels. Further, the user may specify access privileges associated with access to the channel by others. The channel may be associated with the decision system, such that the decision system may host the channel and utilize information within the channel to identify items that may be of interest to the user, and to recommend purchase options to the user. In some embodiments, the decision system may process the provided information to identify a plurality of other channels or potential outcomes and interests that may be similar to the created channel. Such additional outcomes and interests may be recommended as potential additions to the user's channel.

In some embodiments, the user may share one or more channels with another user, with a group of users, or with an entire community of personalized channel users. In an example, the user may authorize the system to share a channel with suppliers to encourage suppliers to submit products that might fit well within the channel. In another example, the user may authorize the system to share a selected channel with another user, such as the user's wife, so that they can collaborate on a particular channel such as by adding information, commenting on various items, removing items, and discussing variations through the shared channel. In some embodiments, the channel may be used by a decision system to select which products from a supplier to show to the user and to filter out other products, for example, based on parameters determined from contents of one or more of the user's channels.

In certain embodiments, when the user (or another user) selects the activities channel, the decision system may identify one or more potential outcomes from a plurality of activities based on parameters identified from the activities channel. In an example, the user may provide data corresponding to a request, such a query intended to a search for an activity (e.g., a show, a spa day, a trip, a tour, another activity, or any combination thereof) to the decision system. In response to the request, the decision system may identify one or more potential purchase options, may determine parameters based on one or more channels associated with the user, and may selectively rank the purchase options based on parameters determined from the user.

In an example, the personalized channel may specify hotels that offer king bed suite accommodations as well as offering both a free breakfast each morning and a manager's reception in the evening. In other embodiments, the personalized channel may relate to various travel products, such as favorite airlines, favorite rental car companies, and so on. It should be appreciated that a channel may be as specific or as general as the user wants it to be. A channel can include a type of product, such as boutique or high end independent hotels. Alternatively, a channel may be customized based on location. For example, the user may create a first channel that indicates that the user likes five-star hotels in the United States, but prefers boutique hotels in the middle east. Other embodiments are also possible.

In certain embodiments, a personalized channel may include a “Beatles-inspired vacation” channel that includes London hotels, a pub tour, and other activities. The decision system may recommend additions to the personalized channel, such as a train ride to Liverpool, a studio tour of the studio where the Beatles recorded their albums, a flight from New York City to London Heathrow airport on a preferred airline, such as an airline indicated to be preferred by the particular user, by one of the Beatles, based on a business relationship, and so on. The system may be configured to extract data from the personalized channel and identify purchase options that correspond to the extracted data, which purchase options may be of interest to the user. The system may provide data related to the identified purchase options to a graphical interface, which can be accessed by the user.

When creating a channel, a user may include text in any language to define the channel content and may add labels or categories to organize the data. The decision system may process the data to identify semantic similarities between one user's search and another user's curated list or channel and may use the semantic similarities to determine purchase options or items of interest to the user.

In some embodiments, the system may allow the user to subscribe to an existing curated list or channel because the user trusts the curator. In certain embodiments, the trusted curator may be a friend that is trusted by the user. Alternatively the trusted curator may be an “expert”. In addition to or in lieu of subscribing to the curated list, the user may take items from the curated channel and add them to one or more of the user's channels.

In some embodiments, the decision system may utilize one or more artificial intelligence engines to determine semantic similarities between a user's request and a curated list (or a list or channel to which the user is subscribed) and may expose the curated list or channel to the user. In an example, a user may search for the “best hotel in Vegas for a crazy bachelor party”, and the decision system may identify a related list including text saying “my list of best wedding experiences.” The decision system may identify similar curated lists and may use the lists either to provide information to the user or to search for information corresponding to a user request.

In certain embodiments, the user may create a hotel channel that may identify Embassy Suites® hotels as being one of the user's favorite hotels. The user can curate a list or channel of any product or service, including hotels, specific rooms in hotels, airlines, a specific seat in a specific plane on a specific flight, a restaurant, other products or services, or any combination thereof. The decision system does not limit the breadth or the precision of the particular channel. Moreover, the decision system may utilize the channel to identify purchase options that are personalized to the user's interests and preferences based in part on the information determined from the channel associated with the particular user.

In the context of a hotel channel, a user may visit the decision system to request or search for a hotel at a destination that is unfamiliar to the user. The decision system may determine the user's favorite hotel chain or may more generally determine the user's hotel preferences (e.g., four-star rating or better, breakfast included, manager's reception, big chain or boutique, minimum review rating, location, or other preferences) based on the hotel channel. Once the user's preferences are determined, the decision system may first look for the user's favorite hotel chain at the destination. If the user does not have a favorite hotel chain but just a series of preferences or if the favorite hotel chain is not available (either no such hotel at the destination or the hotel is completely booked), the decision system may attempt to identify similar hotel accommodations at the destination. In certain embodiments, the decision system may utilize normalized and aggregated inventory data, supplier searches, social media, experts, collective information derived from other users, and other data sources to identify potential outcomes for the consumer. In some embodiments, the system may access other user's channels (which users may have provided permission) or may access a channel shared by an expert to identify potential options for the user. The user may take products from these channels and add them to the user's channel. Alternatively, the system may automatically take such products and add them to the user's channel.

In some embodiments, the system may automatically query one or more of the user's family members, friends, social network, and business colleagues to ask for input. In an example, the system may poll one or more individuals to find out what the user might like or what the other individual might like to identify potential items to be added to the user's channel. Further, in some embodiments, the system may compare a first user to a second user and determine that they are similar enough that the first user might like an item from the channel of the second user.

Further, in certain embodiments, the decision system may allow the user to publish the newly created channel for use by other users of the system. The decision system may reward the user if the user's accommodations channel is selected and may provide an additional award if the use of the user's accommodations channel results in a booking of one or more accommodations.

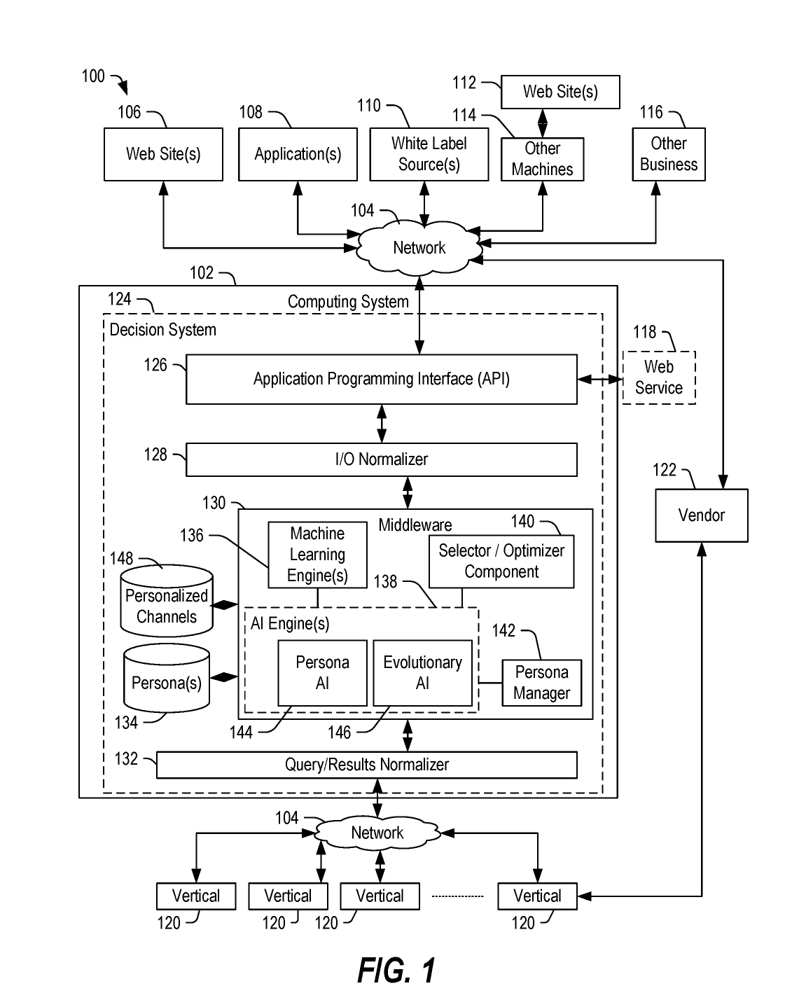

In some embodiments, the decision system may inspire the user to add a product from another user's channel, such as the channels of trusted friends, celebrities, experts, business associates, other users that the system determines have similar tastes, and so on. In some examples, the decision system may recommend products or services from other user's channels, and the user may elect to add one or more of the recommended products or services to his or her channel. Further, the decision system may track such usage and may reward the user who assembled the accommodations channel with redeemable points, for example. Other embodiments are also possible. One possible example of a decision system is described below with respect to FIG. 1.

FIG. 1 is a block diagram of a system 100 including a decision system 124, in accordance with certain embodiments of the present disclosure. The system 100 may include a computing system 102 that can be configured to communicate through a network 104 with websites 106, applications 108 (including mobile applications), white label sources 110 (i.e., private label applications or services), other machines 114, one or more websites 112 through one of the other machines 114, other businesses 116, vendors 122, or any combination thereof. Additionally, the computing system 102 may be coupled to one or more verticals 120 through the network 104. The term “vertical” may refer to a particular market sector, such as travel, financial, healthcare, real estate, entertainment, education, military, retail, grocery and produce, employment, etc. Each of the verticals, identified by reference number 120, may include a plurality of websites, businesses, etc. that service that particular sector. Though each of the verticals 120 is depicted as distinct, it should be understood that the verticals 120 can overlap one another and that a business entity or website may cross multiple verticals, or sub-categories within one or more verticals (sub-verticals).

The computing system 102 can include a decision system 124. The decision system 124 may be configured to allow a user to set up a customized or personalized channel based on the user's interests, such as travel interests, musical interests, and so on. In an example, the user may set up a personalized channel that includes a list of his/her favorite hotels within a travel category. In another example, the user may create a channel corresponding to a particular city, which channel may include a plurality of related and unrelated items that correspond in some way to the particular city.

The personalized channel may be stored and may be retrieved and used on behalf of the user each time the user searches for a purchase option using the decision system 124. The personalized channel may define parameters and preferences for the user that help the decision system 124 to identify suitable purchase options personalized for the user.

In some embodiments, the decision system 124 may associate each channel of a user with a persona of the user. The user may be associated with multiple personas, where each persona represents the user's decision-making at a point of time and in a particular decision-making context (e.g., family, individual, worker, etc.). In some instances, some of the user's channels may be associated with a particular persona of the user, and others of the user's channels may be associated with different personas. For example, the user may have a hotel channel that includes romantic hotels that the user chooses when he is traveling with his wife. However, the user may have a separate hotel channel that includes other types of hotels when the user is traveling alone or with friends.

In certain embodiments, the decision system 124 may allow the user to share his/her personalized channel with other users. Further, the decision system 124 may reward the user with cash or non-cash scrips, such as points, which can be redeemed for hotel accommodations or specialty services (e.g., a romance package, a breakfast package, and the like) or for some other item or service in exchange for sharing the personalized channel or when another user utilizes the personalized channel. In some embodiments, the decision system 124 may also allow users to select a personalized channel corresponding to an expert, to select items from the personalized channel, and to add the selected items to the user's channel.

The decision system 124 may include an application programming interface (API) 126, which may communicate with the websites 106, applications 108, white label sources 110, other machines 114, other businesses 116, web services 118, vendor 122, or any combination thereof. In an example, the API 126 may provide web services 118, such as serving Internet-accessible web pages and associated data to requesting devices or systems and may communicate data to devices or systems that may provide the data in a hosted interface, such as an application interface, a web browser interface, or another type of interface. The web services 118 may be part of the API 126 of the computing system 102 or may be associated with another device or system. The API 126 may coordinate interactions between the computing system 102 and external components, devices, applications, etc. Further, the API 126 may receive data from the network 104 and may provide the data to an input/output (I/O) normalizer 128.

The I/O normalizer 128 can translate received data into a format suitable for processing by middleware 130. In certain embodiments, the I/O normalizer 128 may extract, transform, and load (ETL) received data using an artificial intelligence engine, a machine learning module, previously defined ETL rules, or any combination thereof. In particular, the I/O normalizer 128 may extract data from a received data stream, transform the data into one or more appropriate formats (e.g., transform date information in a form of m/d/yy into a form mm/dd/yyyy; identify textual content to classify the text for loading, and so on), and load the data into a temporary table, which may be provided to the middleware 130. In certain embodiments, the I/O normalizer 128 may be a circuit configured to automatically format the data into a table or other temporary storage.

The middleware 130 may include one or more machine learning engines 136, which may be configured to observe interactions between a device (such as a user's computer or smart phone, an application, another machine, a vendor, and so on) and the computing system 102. The machine learning engines 136 may process metadata about such interactions, process decision-making, and make suggestions to one or more AI engines 138. In certain embodiments, the machine learning engines 236 may attempt to predict decision-making by a particular user based on available options and may learn from differences between the actual interactions and the predicted interactions. Over time, the machine learning engines 136 may become better at predicting decision-making and may adapt their decision-making to improve their predictions for each user.

In some embodiments, the middleware 130 may include one or more artificial intelligence (AI) engines 138, including a persona AI 144 and an evolutionary AI 146. The one or more AI engines 138 may be configured, using personas selected from a plurality of personas 134, to substantially match preferences, habits, and decision-making characteristics of one or more consumers. Each persona may represent the digital decision-making of a particular entity (such as a user) within a particular context and given options available at a particular point in time. In some embodiments, the AI engine 138 may be configured according to a selected persona to perform decision-making on behalf of the user. In some embodiments, the AI engines 138 may be configured with multiple personas corresponding to different aspects of a decision-maker's personality or reflecting different roles that the decision maker may play at different times (e.g., individual, family member, employee, etc.). The configured AI engines 138 may identify outcomes on behalf of the user and may prioritize identified outcomes according to the particular persona.

The middleware 130 may also include a persona manager 142 configured to select one or more personas from the plurality of personas 134 and to configure the persona AI 144 based on the selected personas. Over time, decisions may be made by a user that correspond to or that differ from priorities indicated by the selected personas. The evolutionary AI 146 may process such decisions and may adjust the parameters of one or more of the personas based on such information, allowing personas to evolve (learn) over time. In some embodiments, the evolutionary AI 146 may initiate changes in selected personas based on user interactions with the data, based on information derived from other personas, based on information derived from the “universe” of options, or any combination thereof. The adjusted persona may be stored in memory with the plurality of personas 134.

In some embodiments, the decision system 124 may include a query/results normalizer 132, which may be configured to receive one or more queries and to process the one or more queries into a format suitable for searching one or more data sources. In some embodiments, the queries may be generated automatically by the AI engines 138 based on data received from a user or from another source. The AI engines 138 may generate queries based on the request received from a user, based on collective information, or any combination thereof.

In some embodiments, the API 126 may cooperate with the query/results normalizer 132 to generate the query in a proper format for each of a plurality of potential suppliers. The queries may then be sent to one or more suppliers via the network 104. In some embodiments, at least one of the queries may be directed to a database including aggregated vendor data, which may have been collected, normalized, and stored using web spiders or bots configured to automatically traverse websites and to retrieve data. In some embodiments, the query/results normalizer 132 may be configured to receive results in response to a query or from a variety of sources and may be configured to extract, transform, and load data from the results into a pre-determined format, such as a table having predetermined fields such that the data is in a format suitable for processing using the configured AI engines 138.

In certain embodiments, the API 126 may communicate an interface, such as a web page, to a computing device via the website 106, for example, or via an application 108, such as an application configured to run on a smart phone, a tablet computer, or other computing device. The API 126 may receive input data in response to the interface, such as user selections, user requests, and the like. The API 126 may communicate the data to the I/O normalizer 128.

The I/O normalizer 128 may process the received data. In certain embodiments, the I/O normalizer 128 may extract, transform, and load the received data into a pre-defined format, such as a table or other data structure. The I/O normalizer 128 may provide normalized data to the middleware 130. In certain embodiments, the normalized data may include an indicator corresponding to a particular user or a particular user device.

The persona manager 142 may determine one or more personas from the personas 134 in response to the normalized data or in response to data about the user or user device. The persona manager 142 may configure the persona AI engine 144 according to selected personas. The persona AI engine 144 may produce one or more queries to identify potential outcomes corresponding to the data provided by the consumer and may provide the one or more queries to the query/results normalizer 132, which may normalize a query, data, other information, or any combination thereof into data formatted for a particular one of the verticals 120.

In some embodiments, the query/results normalizer 132 may wrap each query with a “wrapper” that configures the query for a particular data source. In some embodiments, the computing system 102 may have a “wrapper” for each data source, indicating the format and attribute selections used for interacting with a particular data source (such as a vendor 122 or one or more data sources within a selected vertical 120). Each “wrapper” may include an instruction set that can be selected to “wrapper” the query for a particular data source. By “wrappering” a query, the query/results normalizer 132 may configure the query to search a data source associated with each supplier based on a supplier-specific set of instructions or rules. The query/results normalizer 132 may apply the wrapper both to format the query for a particular supplier and to direct the system 102 to conduct the search via a particular supplier (i.e. where to send the data, how to send the data, etc.). The query/results normalizer 132 may receive results from each supplier in response to the query and may process the results according to the supplier-specific instructions, extracting, processing and loading the results into a temporary table of search results. Thus, the query/results normalizer 132 may process the query into formats suitable for each supplier of the particular vertical 120. In some embodiments, one or both of the API 126 and the I/O normalizer 128 may utilize collective information to identify “better” or “best” searches, which may yield better outcomes.

The middleware 130 also uses one or more personas to impact the searches. In an example, the middleware 130 may select one or more personas from personas 134 using the persona manager 142. The middleware 130 may also apply the selected persona(s) to the query using the persona AI engine 144 to perform query expansion, apply modifications or corrections to the query, and add constraints and refinements to the queries according to a selected persona to customize the query to the selected persona. The middleware 130 may provide the processed query to the query/results normalizer 132, which may format the processed query for a particular vertical 120. The query/results normalizer 132 may then provide the wrapped query to one or more data sources associated with the vertical 120. In certain embodiments, the selected digital personas may be applied to the persona AI engine 144 to process the input data to adjust keywords, apply restrictions and query enhancements, and produce queries that are aligned with the specific preferences and restrictions associated with that particular persona. Such preferences and restrictions may be configured by a user, may be learned over time from explicit and implicit feedback from the user's interactions, may be inferred from interactions of various personas, or any combination thereof. The queries produced by the persona AI engine 144 based on each of the selected personas may be normalized by query/result normalizer 132 and may be sent to one or more data sources.

In response to sending the processed and normalized queries to one or more data sources, the computing system 102 may receive results associated with one or more products (or services, e.g., purchase options) in the particular vertical. The query/results normalizer 132 may receive results from multiple data sources and may extract, transform, and load the results into one or more temporary tables, which may be passed to the middleware 130. The persona AI engine 144 may apply one or more selected personas from personas 134 to the results to produce one or more processed results. The processed results may be ranked, sorted, weighed, filtered, processed, or any combination thereof according to each of the one or more selected personas, potentially producing multiple multi-dimensional sets of processed results, which may be provided to the selector/optimizer component 140.

In some embodiments, the middleware 130 can deliver specific facts and circumstances at hand to a persona AI engine 144 with selected digital personas from the personas 134, where each of these selected digital personas offers a potential solution in accordance with the following process: (1) the middleware 130 can produce a solution aligned with specific preferences and restrictions pre-established by the user within each digital persona; (2) the selector/optimizer component 140 can conduct a competition among the outcomes determined from selected digital personas to determine optimal outcomes for the user in the context of the specific facts and circumstances of each user request; and (3) the selector/optimizer component 140 can resolve the multiple potential outcomes presented by the user of the digital persona to produce a set of outcomes.

The decision system 124 may receive results corresponding to each of the normalized queries, and the results from each of the queries provides a basis for competition among the digital personas, which competition may be resolved by the selector/optimizer component 140 to determine optimal outcomes for the particular problem. The results may be normalized by query/result normalizer 132 and provided (together with the associated persona) to the selector/optimizer component 140, which may select between the results or which may selectively combine the results from one or more of the sets of results to produce a plurality of potential outcomes. In some embodiments, the selector/optimizer 140 can process the potential outcomes to determine the “better” or “best” outcomes and can provide the selected outcomes to the I/O normalizer 128, which may extract, transform, and load the data from the selected one of the sets of processed results into a format suitable for the API 126 to provide the results to a destination, which may be a device, an application, a web interface, etc.

In some embodiments, the AI engines 138 may utilize collective information to produce outcomes that may be more valuable to the user than other options. In some embodiments, the decision system 124 may identify one or more purchase options based on preferences determined from the user's channel or channels. In an example, a user may select a four-star hotel at $200 per night (where $200 is the user's maximum price). The decision system 124 may recommend a vacation rental priced at $250 that fits the user's preferences and that may be better than other options, even though it is not a hotel and even though the price is greater than what was requested. In an example, the rental may be closer to an event to be attended by the user or closer to other amenities or more have other advantages based on the context of the trip.

The decision system 124 may develop experience with yield management rules as well as routine price variations over time (based on real world sense checking, adding search variations, etc.), and may determine that such variations can provide better results based on the yield management rules. The AI engines 138 can make use of such information to perform “better” searches that can yield “better” outcomes. Further, the AI engines 138 can use such information to suggest other items for addition to the user's channel. Embodiments of the decision system 124 may be configured to identify potential outcomes and to provide selected ones of the potential outcomes within an interface, which may be rendered as a web page or application interface on a computing device.

In certain embodiments, the decision system 124 may include a database of personalized channels 148. Each channel 148 may be configured by a user based on the user's preferred and favorite purchase options. The data stored in the channels 148 may include parameters associated with the particular purchase option, including factors that led to the user picking the purchase option as his or her favorite or preferred purchase option. In certain embodiments, the decision system 124 may provide a graphical interface to a computing device via a website 106 or an application 108 to allow a user to select and reserve or hold a purchase option, such as a personalized hotel reservation at a particular destination. In certain embodiments, the user may provide a destination input and a selection of a channel 148, and the decision system 124 may provide a plurality of potential outcomes to the graphical interface that correspond to the destination and that satisfy constraints established by the channel 148. The decision system 124 may be configured to semantically process data content of the channel 148 to determine parameters defining the user's preferences and may apply those parameters to limit the purchase options presented to the user. Further, in some embodiments, the decision system 124 may automatically learn from how the user responds to choices presented on the basis of the channel and may apply that learning to update parameters determined from the channel. In some instances, the decision system 124 may combine what the user claims to want with what the user actually wanted (based on the user's explicit and implicit feedback).

In certain embodiments, the user may interact with the graphical interface to configure the personalized channel that may be stored in channels 148, to select other channels, and so on. In certain embodiments, the user may save one or more potential outcomes to a clipboard (i.e., a new tab, a panel, or a new web page) and may select another channel 148 to repeat the search. Potential outcomes from each search may be selectively added to the clipboard to allow the user to compare and choose between various options, to sleep on the decision in order to make decisions at a later time, to share the clipboard with other users, or any combination thereof.

In certain embodiments, the decision system 124 may treat the channel as a set of preferred activities or products for the user. The decision system 124 may allow the user to share his or her personalized channel, and other users may benefit from the insights of the owner of the particular channel 148. In certain embodiments, the decision system 124 may track usage of such channels 148 and may reward the user if another user selects his or her personalized channel. The reward may include cash, non-cash scrips (such as miles or points), discounts, another option, or any combination thereof. Further, additional rewards may be provided if the other user purchases an option via the user's personalized channel from the channels 148. Other embodiments are also possible.

In certain embodiments, the AI engines 138, the machine learning engines 136, or both may include artificial neural networks (ANNs), which may be used to estimate or approximate functions that can depend on a large number of inputs and are generally unknown. The ANN may be presented as one or more systems of interconnected “neurons”, which may be configured to send messages to each other. The connections may be assigned numeric weights that can be tuned based on experience (through training and prediction), making the ANN adaptive to inputs and capable of learning over time. In certain embodiments, the ANN may be part of the AI engines 138, which can include both non-adaptive elements (persona AI engines 144) and adaptive elements (evolutionary AI engines 146). In certain embodiments, the AI engines 138 may utilize a network function (f(x)) to determine potential outcomes. Each outcome may be defined as a composition of a plurality of nested functions, each of which may be associated with a particular variable with respect to the available inventory at any given point in time. The inventory may include products, services, information, or any combination thereof. The variables may be partially dependent on the context and may be partially independent from one another.

In certain embodiments, the AI engines 138 may be configured to solve a class of functions that solve a task in some sense. The task may include travel to a destination, a service, a product, a lodging option (e.g., a hotel, a rental property, and so on) or any combination thereof. The AI engines 138 may define a cost function to determine a value of each possible solution in terms of a selected parameter, such as price, duration, true value, and so on. The machine learning engine 136 and the AI engines may process inventory data and search for inventory that may have a cost function that has the smallest possible cost over the universe of potential options that satisfy constraints associated with the particular task.

In certain embodiments, the decision system 124 may define an ad hoc cost function having properties determined to be desirable based on the selected persona. Some cost functions may naturally arise from a particular formulation of the data request (e.g., “lowest priced flight from Austin, Tex. to London, England departing on June 1”). Ultimately, the cost function will depend on the desired task. It should be appreciated that the airline flight is used herein as an illustrative example, and is not intended to be limiting.

In some embodiments, the decision system 124 may utilize collective knowledge derived from a plurality of users, from channels of other users, from experts, and from the user's inputs to inform searches and to present recommendations and new options for the user to add to his or her channel. In some embodiments, the decision system 124 may search for options in response to a user request, and may identify purchase options that may satisfy the user's request and that may correspond to parameters determined from one or more of the user's channels.

In certain embodiments, the AI engines 138 and the machine learning engines 136 may utilize supervised learning, unsupervised learning, and reinforcement learning. In supervised learning, in certain embodiments, a learning set may be processed to identify cost functions based on selected ones of a plurality of available outcomes. The cost function may be related to a mismatch between selected mappings and the data. The decision system 124 may use a mean-squared error to minimize the error between the network's output predicted outputs and the target values over the data set. In certain embodiments, the cost may be minimized using a gradient descent backpropagation algorithm, which can train the AI engines 138 and the machine learning engine 136.

In unsupervised learning, in certain embodiments, the decision system 124 may receive some data and a suggested cost function to be determined, which can relate to any aspect of the data. The cost function may be dependent on the task (what outcome the system is trying to achieve) and on a priori assumptions (the implicit properties of our model, its parameters and the observed variables). The AI engines 138 and the machine learning engines 136 may independently process the data and the suggested cost function to determine a value of the data. The cost function can be related to the posterior probability of the model given the data.

In reinforcement learning, in certain embodiments, the data may be determined dynamically in response to a request or in response to the agent's interactions with the environment. At each point in time (T), the AI engines 138 may perform an action f(T), and the machine learning engines 136 may generate an observation y(T). The AI engines 138, for example, may search and retrieve potential outcomes and determine an instantaneous cost function c(T) for each potential outcome. The AI engines 138 may selectively prioritize the potential outcomes based on the cost function unique to selected ones of the one or more personas. In certain embodiments, the decision-making process performed by the AI engines 138 and the machine learning engines 136 may be modeled as Markov decision processes including states {s₀, . . . , sₙ} and actions {a₁, . . . , aₘ} having the following probability distributions: the instantaneous cost distribution P(c_t|s_t), the observation distribution P(X_{T}|S_{T}) and the transition P(S{t+1}|S_{T}, A_{T}), while a policy is defined as the conditional distribution over actions given the observations. In certain embodiments, the observation distribution and the transition may define a Markov chain that can be used to evaluate the cost of the various potential outcomes.

In certain embodiments, the AI engines 138 and the machine learning engines 136 may learn from an initial set of data (structured learning) and then may learn from unknown data sets (unstructured and reinforcement learning). Further, the AI engines 138 and the machine learning engines 136 may strive to provide enhanced searches to improve on the data requested by the user. Further, even after a purchase event, the decision system 124 may be configured to continuously search for “better”. In certain embodiments, the decision system 124 may process each potential outcome into parameter segments, assuming that each segment may be independently selectable, to produce decision trees from which the potential outcomes may be selected.

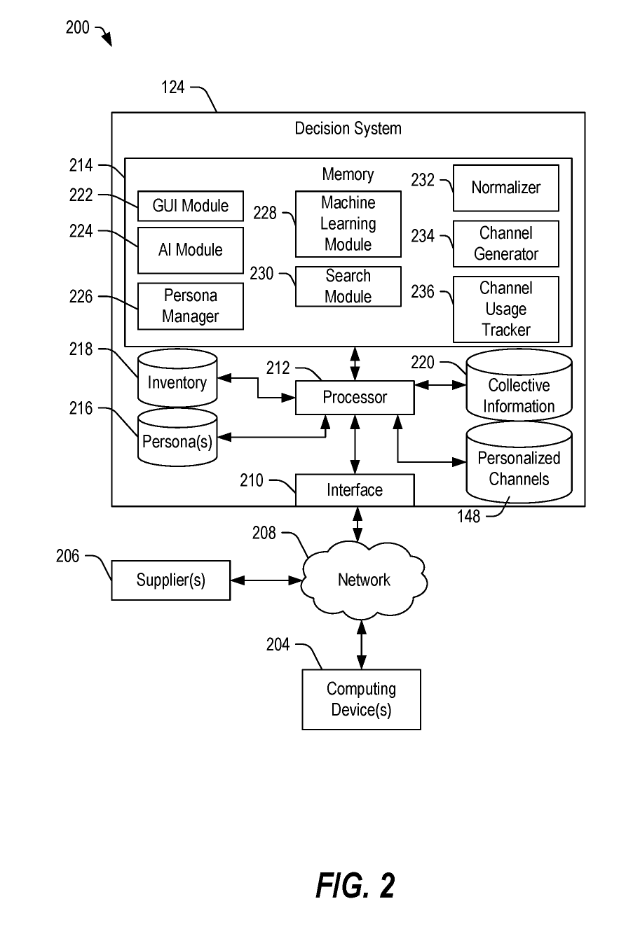

FIG. 2 is a block diagram of a system 200 including a decision system 124, in accordance with certain embodiments of the present disclosure. The system 200 may include one or more computing devices 204 and one or more suppliers 206, both of which may be coupled to the decision system 124 through a network 208, such as the Internet.

The decision system 124 may include an interface 210 configured to communicate data to and receive data from the network 204. The decision system 124 may also include a processor 212 coupled to the interface 210. The processor 212 may also be coupled to a memory 214, a database including one or more personas 216, a database including inventory data 218, the rental channel data 148, and a database including collective information 220. The collective information 220 may include search logic, decision-making, outcomes, and other information derived from other users of the decision system 124 over time. The inventory data 218 may be normalized data that was previously retrieved from various supplier sites, extracted, transformed, and loaded in the database in a pre-defined data structure suitable for further processing by the processor 212.

The memory 214 may include a graphical user interface (GUI) module 222 that, when executed, may provide an interface to a device for receiving data, for providing information, for receiving selections, or any combination thereof. In some embodiments, the interface may be a graphical interface, such as a web page, which can be rendered and displayed by a computing device, such as one of the computing devices 204. In some embodiments, the graphical interface may be accessed by a user to generate a personalized channel, which may be stored in a database of personalized channel information 148.

In some embodiments, the memory 214 may include an artificial intelligence (AI) module 224 that, when executed, may cause the processor 212 to determine outcomes for a consumer in response to data received from the GUI or from other processes or applications. The AI module 224 may be configured using one or more personas 216, each of which may correspond to a particular entity at a point in time. The memory 214 may further include a persona manager module 226 that, when executed, may cause the processor 212 to select one or more of the personas from the personas database 216 and to configure the AI module 224 with the selected personas. The configured AI modules 224 may identify and prioritize outcomes based on the selected personas. In some embodiments, the AI module 224 may be configured to automatically update the user's channel to reflect changes in the universe of options, even when the user is largely inactive with respect to his or her channel, thereby preventing the channel contents from becoming stale and out-dated. The AI module 224 may add items to various categories (or at least update recommendations for various categories) within the personalized channel, based on changes in the universe of options, based on other users, based on expert users, and so on.

In some embodiments, the memory 214 may also include a machine learning module 228 that, when executed, may cause the processor 212 to learn from interactions between the system 124 and other computing systems, between the system 124 and suppliers 206, and between the system 124 and users or user devices. The machine learning module 228 may cause the processor 212 to make recommendations, to suggest alternative outcomes, and to assist the consumer in his or her decision-making.

In certain embodiments, the memory 214 may include a search module 230 that, when executed, may cause the processor 212 to perform searches in response to received data. The received data may include a query from a device, a user, a process, or any combination thereof. In some embodiments, the data may include date, departure, destination, or other travel-related information, other information, or any combination thereof. In some embodiments, the data may include a query for a lodging, such as best hotel in Los Vegas, best place to stay at a particular destination for a party trip, or some other query. In some embodiments, the query may be related to a car rental or an activity (such as a tour, an event, a performance, a presentation, a speech, etc.). Other embodiments are also possible.

In some embodiments, the received data may be received from the machine learning module 228, from the AI module 224, from another module, or any combination thereof. The search module 230 may be configured to search in response to a request, and optionally to search continuously to find “better” outcomes. In certain embodiments, the continuous search option may be configured by a user as an optional feature.

The memory 214 may include a normalizer module 232 that, when executed, may cause the processor 212 to process received data into a format that is standardized for the decision system 124. Further, the normalizer module 232 may process queries into one or more formats suitable for searching various data sources to retrieve information. Additionally, in some embodiments, the normalizer module 232 may further process data from retrieved results (such as travel options, outcomes, and so on), in the format that is standardized for the decision system 124 for further processing. In some embodiments, the decision system 124 may receive inventory information from various suppliers, which inventory information may be processed by the normalizer 232. The normalizer 232 may process the information by extracting, transforming, and loading the data into a pre-defined data structure, which may be stored in inventory database 218.

In certain embodiments, the memory 214 may include a channel generator 234 that, when executed, may cause the processor 212 to utilize the GUI module 222 to generate a graphical interface to prompt the user to answer survey questions about favorite purchases, favorite options, favorite activities, and so on. The channel generator 234 may cause the processor 212 to receive data from the user and to assemble the information to generate a personalized channel, which may be stored in channel data 148.

In certain embodiments, the memory 214 may further include a channel usage tracker 236 that, when executed, may cause the processor 212 to receive data corresponding to selection and usage of a shared one of the personalized channels from the personalized channel data 148. The channel usage tracker 236 may determine usage, and may reward a user associated with the personalized channel based on the usage. Further, the channel usage tracker 236 may provide additional rewards when another user selects a purchase option corresponding to one of the items in the user's personalized channel.

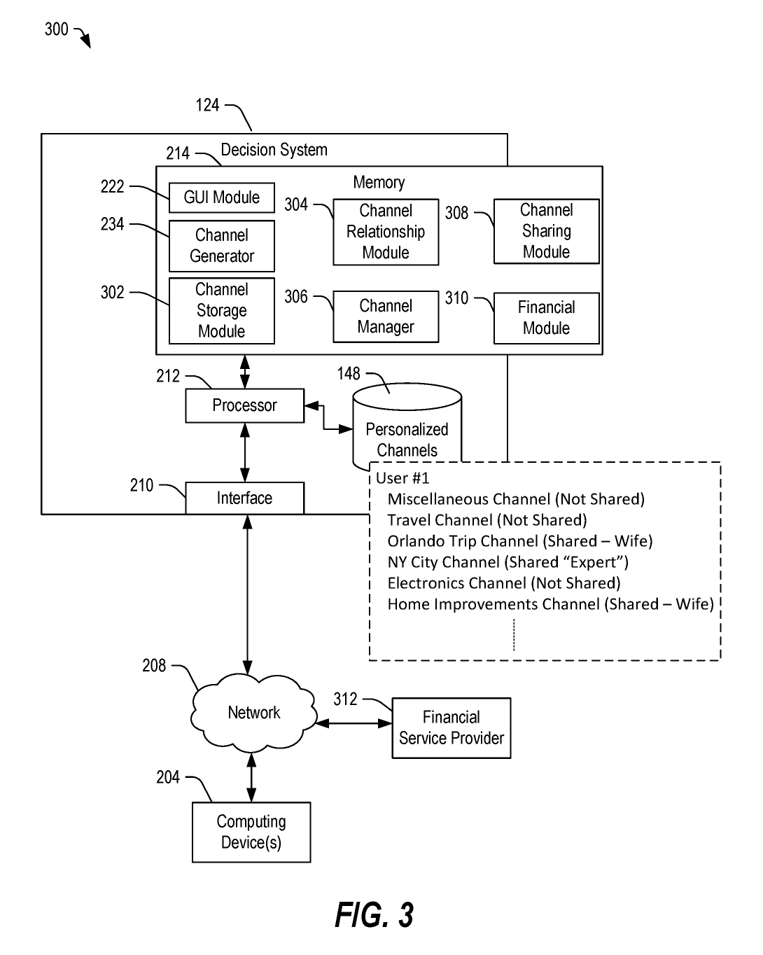

FIG. 3 illustrates a block diagram 300 of the decision system 124 of FIG. 2, and includes an example of some channels owned by a particular user, in accordance with certain embodiments of the present disclosure. The decision system 124 may include all of the elements of the decision system of FIG. 2 and may include additional features.

The memory 214 may include a GUI module that, when executed, may cause the processor 212 to provide a graphical interface to a computing device 204, which may be associated with a user. The graphical interface may include information as well as user-selectable elements accessible by the user to establish a user account with the system and to interact with the account to create one or more channels that can be owned by the user and that the user may elect to share with others.

The memory 214 may include a channel generator 234 that, when executed, may cause the processor 212 to receive data from the user and to generate a channel for the user based on the data. The data may include an identifier as well as information about the channel. In some instances, the data can also include links, text, images, or other data. The user may interact with the graphical interface to save the information. The memory 214 may include a channel storage module 302 that, when executed, may cause the processor 212 to store the channel data and an identifier associated with the user in a database 148 that includes a plurality of personalized channels. The memory 214 may further include a channel relationship module 304 that, when executed, may cause the processor 212 to determine relationships between one of the user's channels and another channel. The relationship may be between one or more of the user's channels or between one of the user's channels and a channel owned by another user. Other embodiments are also possible.

The memory 214 may include a channel manager 306 that, when executed may cause the processor 212 to determine parameters associated with the content of the user's channel. The channel manager 306 may further cause the processor to identify items of interest to the user based on parameters. The decision system 124 may identify options by searching or may identify options from other user's channels or from expert channels. In some instances, the channel manager 306 may cause the processor 212 to update channel content on behalf of the user based on such identified options. Other embodiments are also possible.

The memory 214 can include a channel sharing module 308 that, when executed, may cause the processor 212 to share a user's channel with another user or with multiple other users based on settings configured by the user. In some embodiments, the settings may enable different levels of access (e.g., read only, read and write, and so on). The channel sharing module 308 may be configured to moderate the usage of the shared channel according to the preferences.

The memory 214 may include a financial module 310 that, when executed, may cause the processor 212 to enable financial transactions through the graphical interface provided by the GUI module 222. The financial module 310 may be configured to link to an account of the user that is held by a financial service provider 312 (such as a bank, a credit company, a business, or any combination thereof). In some embodiments, the user may configure a channel to include an item of interest to the user. The user may link the item to the financial institution in order to create a “Save Up” functionality, to enable the user to save up money to purchase the item. In an example, the user may configure automatic withdrawal from a bank account to an account associated with the item. In some instances, if the channel is a shared channel, others may access the “Save Up” functionality to contribute toward the user's wish list. When the decision system 124 determines that the user has saved sufficient funds to complete the purchase of the item for which the “Save Up” functionality was added, the decision system 124 may alert the user to acquire authorization to complete the transaction using the stored funds. In some embodiments, once the funds have been saved, the decision system 124 may be configured to automatically purchase the option on behalf of the user.

In the illustrated example, the personalized channels 148 may include multiple personalized channels. Each user may own one or more personalized channels. In this example, a first user (“User #1”) may own a Miscellaneous channel that can include numerous related or unrelated products. Further, the first user may own a “Travel Channel”, an “Orlando Trip Channel”, a “New York City Channel”, an “Electronics Channel”, a “Home Improvements Channel”, and other channels. The channels may be dedicated to one type of product or may include numerous related or unrelated items. In some embodiments, the channel manager 306 may cause the processor 212 to create a new channel for the user in a particular subject area, and may determine content for the channel based on the user's other channels associated with other areas or subject matters.

While only one user is shown, it should be appreciated that multiple user accounts may be included, each of which may be associated with one or more personalized channels 148. Further, the personalized channels can be selectively shared with one or more other users or may be kept private, depending on the user's settings. Further, the user may elect to share one of his or her channels for a fee, e.g., a channel rental. Other embodiments are also possible.

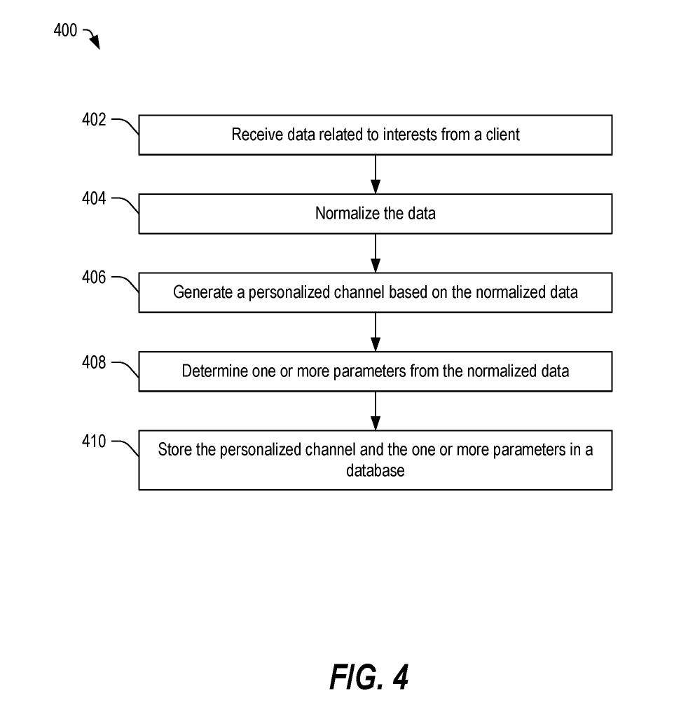

FIG. 4 is a flow diagram of a method of creating a personalized channel, in accordance with certain embodiments of the present disclosure. At 402, the method 400 may include receiving data from a user. In the context of a travel accommodations channel, the data may include hotels, resorts, cabins, rental properties, or other items of interest to the user, associated details and associated comments. In the context of activities, the data may include concerts, museums, sports activities, and the like. In other contexts, the data may include information that is specific to a location, specific to a type of product, specific to an event, or generalized to encompass products, places, and services that may be related or unrelated. In some embodiments, the data may include other information, such as interest information, event information, request information, and the like.

At 404, the method 400 may include normalizing the data. For example, the data may be normalized using the I/O normalizer 128 in FIG. 1 or the normalizer module 232 in FIG. 2. The normalizer may extract, transform, and load the data from the user's responses into a table for storage in the personalized channels 148. Further, in some embodiments, the normalizer may also convert request data from the user into a suitable format for each supplier.

At 406, the method 400 may include generating a personalized channel based on the normalized data. As discussed above, a user may create any number of channels, and each channel may have different content. It should be appreciated that the channels may be configured to host a wide variety of information, including text, video, images, selectable links, and other information. In certain embodiments, the personalized channel may include recommendations.

At 408, the method 400 may include determining one or more parameters from the normalized data. The one or more parameters can include room size information, price information, other information, or any combination thereof. The one or more parameters may also include a generalized understanding of the user's preferences. In some embodiments, the one or more parameters may also be derived from social media comments, responses from the user, collective information derived from other users, information determined from friends, co-workers and business associates, information determined from other sources, or any combination thereof.

At 410, the method 400 may include storing the personalized channel and the one or more parameters in a database. In certain embodiments, the personalized channel may be assigned a unique identifier and may be linked with a user account so that the channel can be managed independently of other channels owned by the user.

In general, the user may update his or her channel by copying images, inserting URL data, adding text, or any combination thereof. The user may categorize the information by specifying the existing categories into which the information may be loaded, or may add a new category. Alternatively, the system may automatically process the information provided by the user and may automatically categorize the uploaded data. In some embodiments, such as where the user has shared a channel with another user, such as a friend or spouse, the friend or spouse may interact with a graphical interface to update the channel, such as by adding or removing items or by commenting on one or more items. The channel may enable a conversation or collaboration around a plurality of selected elements. Other embodiments are also possible.

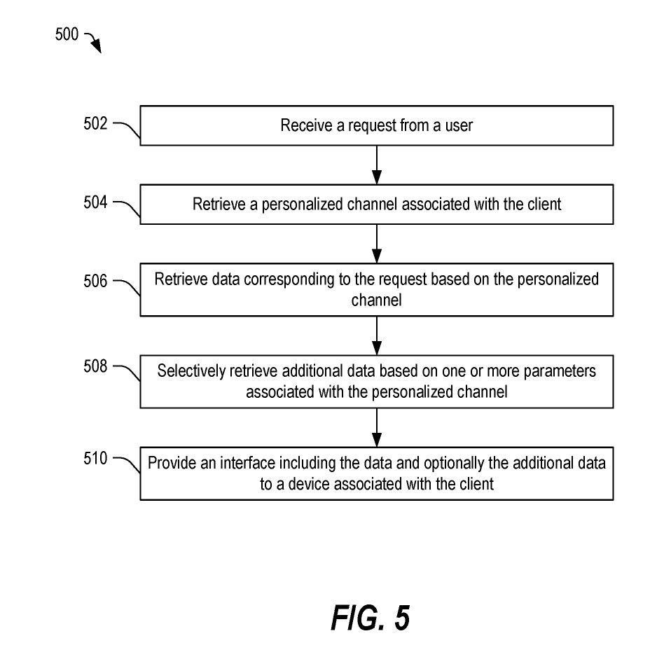

FIG. 5 is a flow diagram of a method 500 of using a personalized channel, in accordance with certain embodiments of the present disclosure. At 502, the method 500 may include receiving a request for a rental from a user. In certain embodiments, the request may include destination information, timing information, other information, or any combination thereof. The user may be a computing device (such as a smart phone, a tablet computer, a laptop computer, a desktop computer, or another computing device) operated by a user or by an autonomous agent (such as an artificial intelligence agent).

At 504, the method 500 may include retrieving a personalized channel associated with the user. The personalized channel may be retrieved from the personalized channel data 148. At 506, the method 500 may further include retrieving rental data corresponding to the request based on the personalized channel. In certain embodiments, the personalized channel may define a plurality of constraints that may be used to filter, refine and identify potential outcomes that correspond to the user's preferences.

At 508, the method 500 may include selectively retrieving additional rental data based on one or more parameters associated with the personalized channel. In certain embodiments, the one or more parameters may include information determined from interests specified by the user when setting up the channel or subsequently determined based on changes/additions to the personalized channel by the user.

At 510, the method 500 may include providing an interface including the rental data and optionally the additional rental data to a device associated with the user. The data may be provided within a web page or an application interface, which may be sent to the user via the API 126. It should be appreciated that the web page or application interface may be provided to any computing device, including a smart phone, a laptop, a tablet, or other device capable of executing software or browsing the Internet. Other embodiments are also possible.

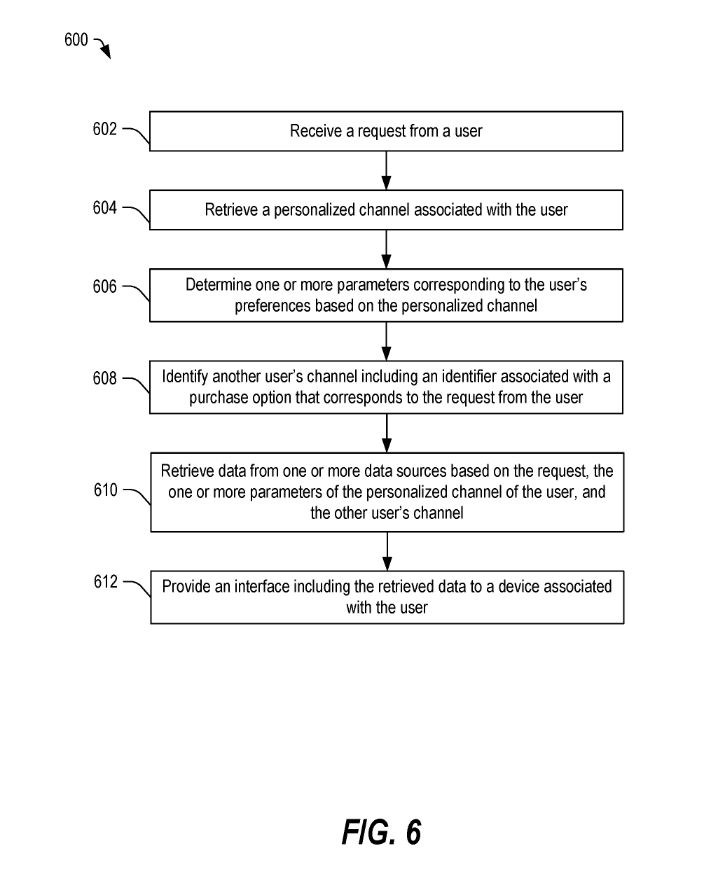

FIG. 6 depicts a flow diagram of a method 600 of using a personalized channel, in accordance with certain embodiments of the present disclosure. At 602, the method 600 may include receiving a request from a user. The request may be received via a web page submission from an Internet browser application executing on a device associated with the user, for example.

At 604, the method 600 can include retrieving a personalized channel associated with the user. The system may utilize identifying information associated with the user (such as login information) to determine and retrieve the personalized channel. At 606, the method 600 may include determining one or more parameters corresponding to the user's preferences based on the personalized channel. The determined parameters may be based on one or more categories that relate to the user's request.

At 608, the method 600 can include identifying another user's channel including an identifier associated with a purchase option that corresponds to the request from the user. In some embodiments, the system may identify the other user's channel based on semantic similarities and overlapping purchase options, for example. Similar interests, similar behaviors, similar interactions, similar like and dislikes, and other similarities may be determined from such analysis, and may be used as a basis for determining that the likes of the other user may be similar to those of the current user.

At 610, the method 600 may include retrieving data from one or more data sources based on the request (from the user), the one or more parameters of the personalized channel of the user, and the other user's channel. In some examples, the other user may be an “expert” with respect to the particular request submitted by the user, and the system may utilize information from the “expert” to inform the purchase options or recommendations provided to the user. In an example, the status of “expert” may be determined based on frequent visits to a destination, a similarities between the user's favorites and those of other users, other indicators, or any combination thereof. Further, in some instances, the other user may be one of the user's trusted friends or business associates or a specially selected user, such as a celebrity or an expert.

At 612, the method 600 can include providing an interface including the retrieved data to a device associated with the user, such as a smartphone, a tablet, a laptop, or another computing device. The interface may include a web page that may be rendered within an Internet browser application executing on the user's device. The retrieved data may include one or more purchase options and user-selectable options for interacting with the purchase options, the search parameters, or both.

In an example, if the user is traveling to a destination and is searching for hotel accommodations, the system may look at the user's channel to determine favorite hotel accommodations. If one of the user's favorites is at the destination, the system may provide one or more rooms from that particular hotel in a list of potential purchase options. Further, the system may look for other hotels at the destination to identify other options that may be of interest to the user. In some embodiments, the decision system may process the user's channel or channels to determine and attempt to understand the values and attributes that are important to the user. The determined information can be used by the decision system to determine what choices to show that may meet the values and attributes that are important to the user, even if those choices do not appear to be similar at face value. Further, in some embodiments, even if one of the user's favorite choices is available, the decision system may be configured to show a non-favorite “exceptional” choice to the user and include a suggestion that the user may like the particular choice or may want to add the choice to the channel.

In addition or when the system can't find a hotel corresponding to the user's favorite or to the user's preferences, the system may try to utilize recommendations from experts, from trusted friends or business associates, from family and so on by reviewing their personalized channels and may inform the purchase options based on such information. In some instances, the decision system may query experts, friends, family, or others to identify potential choices that the user may like. In other instances, the user may ask the system for recommendations. This can be a two-way process. Other embodiments are also possible.

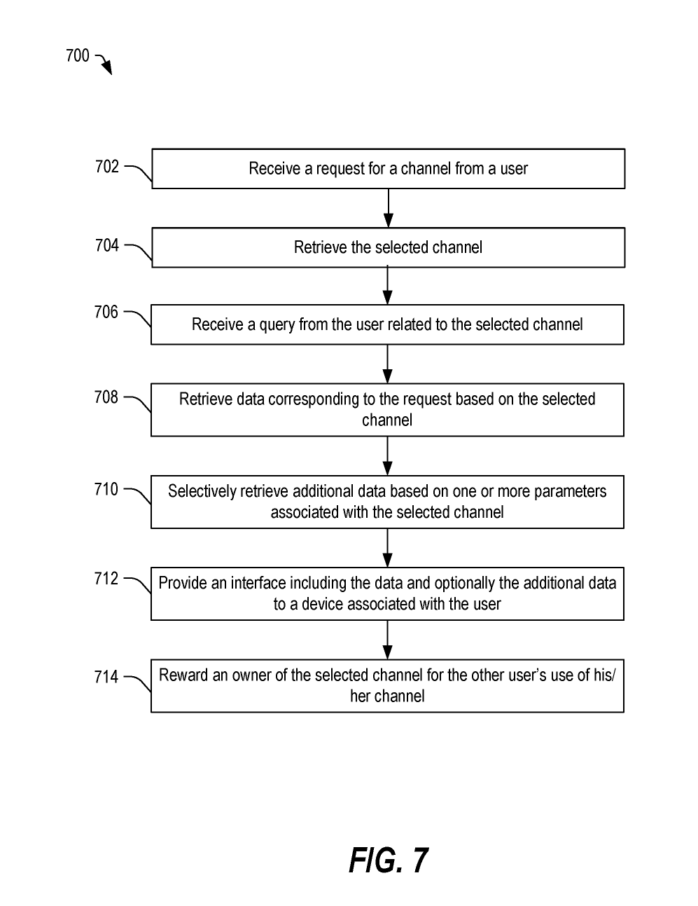

In a particular embodiment, the user may access the decision system 124 and select a personalized channel 148 to search for something that meets his or her criteria (as defined by the channel). In certain embodiments, the decision system 124 may identify choices that satisfy the criteria specified by the user and that meet the parameters/preferences established by the selected personalized channel 148. In certain embodiments, a user may allow his or her personalized channel to be shared with other users. One possible example of a method of accommodation channel sharing is described below with respect to FIG. 7.

FIG. 7 is a flow diagram of a method 700 of allowing another user to use a personalized channel, in accordance with certain embodiments of the present disclosure. At 702, the method 700 may include receiving a request for a personalized channel from a user. In certain embodiments, the request may correspond to selection of a link or button provided in a graphical interface.

At 704, the method 700 may include retrieving the selected personalized channel from a plurality of channels in a database. At 706, the method 700 may also include receiving a query from the user related to the selected channel. The query may be related to any subject area. In some embodiments, the request (in 702) and the query (in 706) may be received as part of the same receiving step.

At 708, the method 700 may include retrieving data corresponding to the request and based on the personalized channel. The decision system 124 may search inventory (normalized and aggregated data as well as supplier data) and may normalize the results to produce the retrieved data. The decision system 124 may then prioritize and filter the retrieved data based on the selected personalized channel to produce the results.

At 710, the method 700 may further include retrieving additional data based on one or more parameters associated with the personalized channel. In certain embodiments, the decision system 124 may attempt to identify additional choices or other personalized options that are substantially similar to the parameters associated with the personalized channel or that represent great options based on the system's understanding of what the user is looking for and based on the understanding of the channel.

At 712, the method 700 may also include providing an interface including the data and optionally the additional data to a device associated with the user. The interface may be a web page, an application interface, or another interface and may be accessible via a computing device, such as a smart phone, a tablet computer, a laptop computer, or any other computing device capable of communicating with the Internet. In certain embodiments, the interface may include one or more user-selectable elements (such as pulldown menus, buttons, links, and the like), which may be accessed by the user to select and book a potential outcome.

At 714, the method 700 may include rewarding an owner of the personalized channel for the other user's use of his or her channel. In certain embodiments, a celebrity, an expert, or another user may share his or her personalized channel. Other users may select the personalized channel for their own use. The decision system 124 may award cash bonuses or non-cash scrips to the owner of the personalized channel, which may be redeemed by the user. In certain embodiments, the non-cash scrips (e.g., credits or points) may be used to book personalized options, to reduce the price of a particular accommodation, and so on.

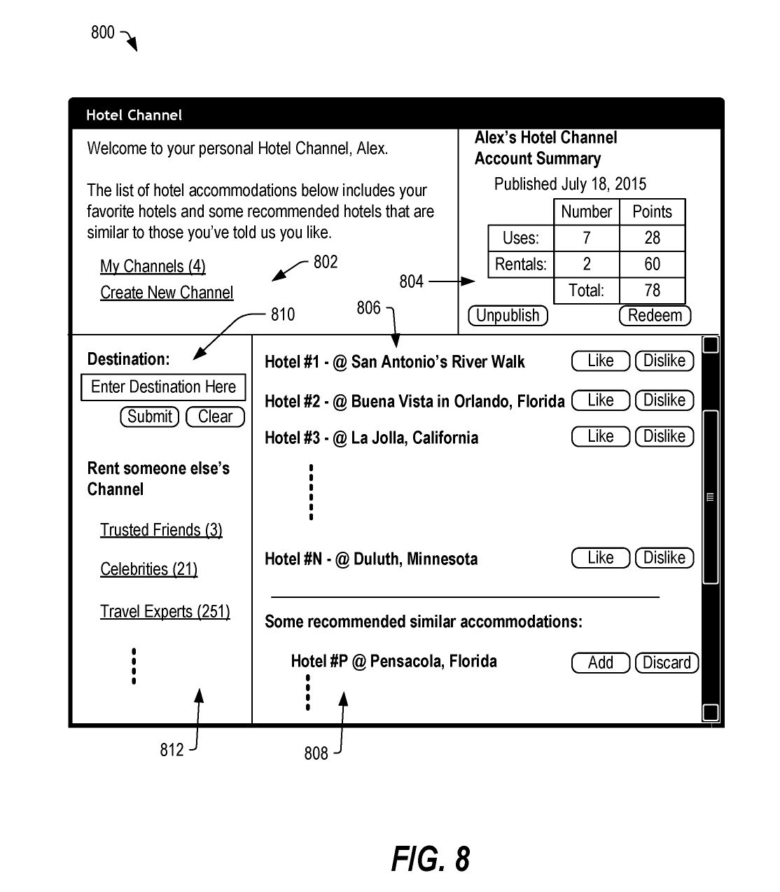

FIG. 8 is a graphical interface 800 accessible to configure, manage, and use one or more personalized channels, in accordance with certain embodiments of the present disclosure. The graphical interface 800 may include a first portion 802 including a welcome message and including selectable links to access one or more existing channels or to create a new channel for the user.

The graphical interface 800 may include an account summary 804 for the selected hotel channel. In the illustrated example, the account summary 804 includes a number of uses by various users and corresponding usage points, a number of rentals and corresponding rental points, and a total. The account summary 804 further includes a first button to un-publish (discontinue sharing or remove) the channel and a second button to redeem accumulated points. In certain embodiments, use of the user's channel may cause the decision system to award a first number of points to the user (owner). If the results produced by the use of the user's channel results in a purchase or rental, the decision system may award a second number of points to the user (owner). In the illustrated example, each use of the channel is worth four points, and each purchase is worth thirty points. Other point breakdowns are also possible.

The graphical interface 800 may select favorites 806, which may include a list of favorite personalized options added by the user. The favorites may be shown in a list together with user-selectable buttons that allow the user to promote or demote the particular favorite, or to “like” or “dislike” the listed favorite. The graphical interface 800 may further include recommendations 808 that may be similar to and based on the favorites 806. The graphical interface 800 may also include a search option 810 that can be accessed to search personalized options at a particular destination. Further, the graphical interface 800 may include a list of other available channels 812, such as “Trusted Friends”, “Celebrities” “Family”, “Business Associates”, “Travel Experts”, and so on. A number of options in each category may also be shown. Other embodiments are also possible.

In the above discussion, the personalized channel was discussed largely with respect to travel and travel products, which items are easy to understand in the context of personalized channels. However, it should be understood that a user may establish a personalized channel for any product, destination, activity, service, or other item of interest to the user. Further, a channel may extend across verticals, and may include different types of products and services, which may or may not be related apart from their association with the channel. The decision system may review the information provided by the user in setting up the channel and may utilize semantic processing via the AI engines 138 and the machine learning module 136 to identify related channels of other users. The decision system may recommend options for inclusion in the user's channel, and the user may be inspired to adopt options from other user's channels and vice versa. Further, the user may publish his/her channel, may establish customized incentives around elements within his channel (such as by negotiating a finder's fee for driving traffic to a particular supplier), and so on. Other embodiments are also possible.

Also, the user may like or dislike options on any part of the personalized channel (either options the user originally selected or options suggested by the system). Further, the decision system may observe how the user interacts with and responds to the options, which can make the decision system smarter in terms of what types of options to recommend to the user and optionally for inclusion in the user's personalized channel. In some embodiments, interactions by the user on a particular channel can inform another channel of the user. For example, user interactions with his “Hotel” channel can inform his “Airline Flights” channel in terms of values sought and luxury expected. Further, the user may view other user's channels, add content from another channel, look for similarities between the user's channel and other users or friends, family or business associates, rent the channel out, and so on.

The user may create a personalized channel for any interest, including flights, hotels, rental cars, activities, vacation rentals, trip ideas, museum tours, concerts, baseball games, automobiles, and so on. Any item of interest to the user may be used to initiate a channel, and the channel content and user's interests may grow and evolve over time, which interests may be reflected by changes to the content of the channel.

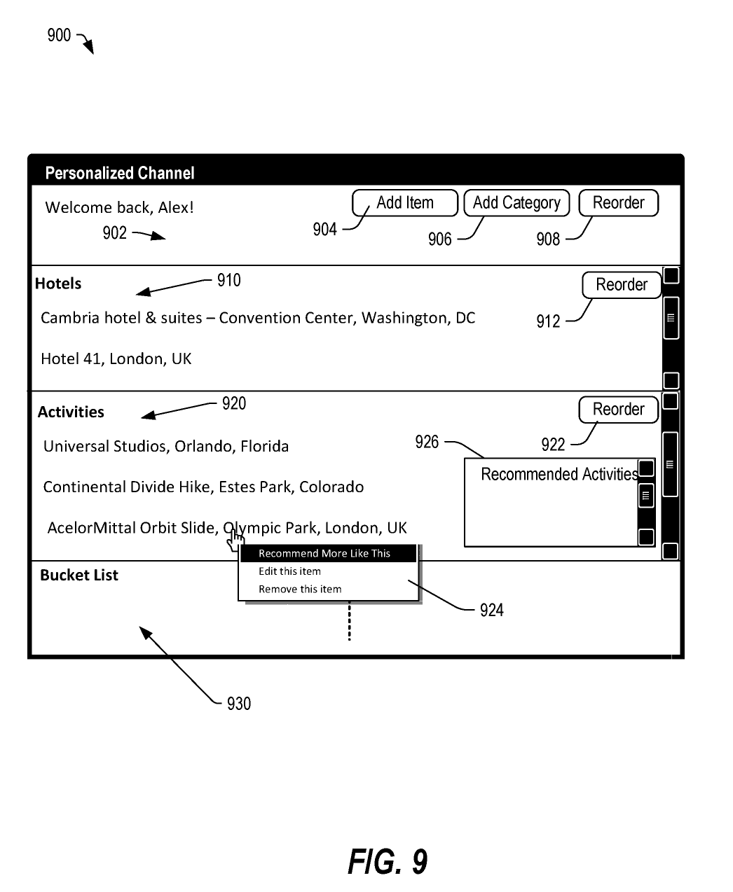

FIG. 9 depicts a graphical interface 900 that may be accessed by a user to configure, manage, and use one or more personalized channels, in accordance with certain embodiments of the present disclosure. The graphical interface 900 may include a control pane 902 including identifying information and including a plurality of user-selectable elements including an “Add Item” button 904, an “Add Category” button 906, and a “Reorder” button 908.

The graphical interface 900 may also include multiple categories of options that the user has added to his or her personalized channel. In an example, the user may have added a hotel category 910, an activities category 920, a bucket list 930, and other categories. Within the hotels category 910, the user may have added at least two hotels (one in Washington, D.C. and another in London), and the category 910 may include a user-selectable button 912 accessible by a user to reorder the list. Similarly, the activities category 920 may include a user-selectable button 922 accessible by the user to reorder the list.

The bucket list 930 may be used to add items, purchase options, activities, and other things that the user may want to accomplish at some point. In some instances, the user may populate the bucket list 930 both to remind him or herself of things that he or she wants to do and to provide an easy spot for storing such information. The system may identify opportunities for accomplishing items on the bucket list when the user utilizes the system to search for various things. In some embodiments, the system may also offer promotions that may be of interest to the user. Other embodiments are possible.

In the illustrated example, the user may right-click on an option to expose an associated menu, such as the menu 924. In this example, the user has selected a “Recommend More Like This” option, which may cause the system to semantically process the information associated with the selected option and to search its database to identify semantically similar activities. Once the system identifies such activities, the system may update the “Recommended Activities” area 926 to provide an opportunity for the user to add one or more of the recommended activities to his activities 920.

In some embodiments, the recommendations area may be displayed dynamically to provide those options to the user for review. Further, in some embodiments, the graphical interface 900 may provide such recommendations independent of any action by the user, suggesting items that may be of interest to the user based on information already added to the channel by the user, by the system, or by an authorized user (such as the user's wife or friend). In certain examples, the system may be configured to automatically update the user's channel to reflect changes in the universe of options, even when the user is largely inactive with respect to his or her channel, thereby preventing the channel contents from becoming stale and out-dated. Other embodiments are also possible.

In conjunction with the systems, methods, and devices described above with respect to FIGS. 1-9, a decision system may allow a user to set up a customized personalized channel based on the user's interests, purchases, wants, and dreams, for example. The personalized channel may include travel options, accommodation options, activities, items of interest, and so on. The personalized channel may be stored and may be retrieved and used on behalf of the user each time the user searches for personalized options through the decision system. The personalized channel may define parameters and preferences for the user that help the decision system to identify suitable personalized purchase options, activities, and so on.

In certain embodiments, the decision system may allow the user to share his/her personalized channel with other users. Further, the decision system may reward the user with cash or non-cash scrips, such as points, which can be redeemed for some other item or service. In some embodiments, the decision system may allow users to select a personalized channel and to compare results based on a request. Other options are also possible.

The processes, machines, and manufactures (and improvements thereof) described herein are particularly useful improvements for computers using artificial intelligence based decision systems. Further, the embodiments and examples herein provide improvements in the technology of artificial intelligence based decision systems. In addition, embodiments and examples herein provide improvements to the functioning of a computer by providing enhanced results and dynamic intelligent decisions, thereby creating a specific purpose computer by adding such technology. Thus, the improvements herein provide for technical advantages, such as providing a system in which a user's interaction with a computer system and complex or voluminous results or decisions are made easier. For example, the systems and processes described herein can be particularly useful to any systems in which a user may want to buy, lease, rent, search, exchange, bid, or barter for goods or services. The systems may allow a user to produce a personalized channel that includes a plurality of purchase options, activities, and the like. The system may utilize such information to enhance and refine results for searches performed in response to requests submitted by the user.

Further, the improvements herein provide additional technical advantages, such as providing a system in which the personas can operate continuously, apply experiential learning to perform tasks, solve problems, make recommendations, and assist the user by helping manage the user's life experiences to make the user's life easier in terms of dealing with problems, anticipating and solving problems (sometimes before the user is even aware that a problem may exist), managing tasks, and ensuring that all aspects of the user's life receive due attention. The system may continuously identify refinements and additions to the user's personalized channel, and may provide a user-selectable interface through which the user may add such recommended items or options. Further, the user may authorize the system to automatically add choices to his or her channel.

Moreover, the system provides a venue through which the user may lease, rent or otherwise share his or her personalized channel with other users to assist them in their searches and decision-making and vice versa. Further, the decision system may facilitate group planning as users can collaborate effectively on a trip using channels. For example, each user in a group can add an item to a group channel, such as a channel corresponding to a trip to Mexico, or can comment on an item in channel. The members of the group may communicate via the channel in order to assemble a final list of products or services acceptable to all. Further, the event can be linked to a financial account, enabling the user and optionally other members of the group to use the decision system to save for the trip, paying for items in the channel as the funds are accumulated, and creating a payment account for the channel more generally.

In some embodiments, the decision system may also facilitate the user's bucket list by maintaining the bucket list, by recommending additions to the bucket list, and by presenting options to the user that may facilitate the user successfully checking items off of the bucket list. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A decision system comprising:
an interface configured to couple to a network;
a processor coupled to the interface; and
a memory coupled to the processor, the memory configured to store instructions that, when executed, cause the processor to:
receive data indicating interests of a user;
create a personalized channel associated with the user based on the received data;
in response to a user request, utilize data from the personalized channel to identify one or more options corresponding to preferences determined from the personalized channel; and
provide an interface including the one or more options to a device associated with the user.

2. The decision system of claim 1, wherein the memory further includes instructions that, when executed, cause the processor to selectively share the personalized channel with one or more other users based on a preference specified by the user.

3. The decision system of claim 2, wherein the memory further includes instructions that, when executed, cause the processor to award points to the user when another user utilizes the personalized channel.

4. The decision system of claim 1, wherein the user owns multiple personalized channels, and wherein the memory further includes instructions that, when executed, cause the processor to:
determine user interactions with a first channel of the multiple personalized channels; and
automatically update a second channel of the multiple personalized channels based on the determined user interactions.

5. The decision system of claim 1, wherein the personalized channel comprises at least one of a travel channel, a hotel channel, a location channel corresponding to a particular location, an event channel corresponding to an event, a product channel, and a service channel.

6. The decision system of claim 1, wherein the user owns multiple personalized channels, and wherein the memory further includes instructions that, when executed, cause the processor to:
automatically identify choices of interest to the user based on values and preferences determined from one or more personalized channels owned by the user; and
recommend one or more of the identified choices to the user for adding to the personalized channel.

7. The decision system of claim 1, wherein the user owns multiple personalized channels, and wherein the memory further includes instructions that, when executed, cause the processor to:
automatically identify choices of interest to the user based on values and preferences determined from one or more personalized channels owned by the user; and
automatically update at least one of the multiple personalized channels to include data related to one or more of the identified choices.

8. The decision system of claim 1, wherein the memory further includes instructions that, when executed, cause the processor to:
determine a personalized channel associated with another user based on one or more parameters associated with the other user or the personalized channel of the other user that correspond to the user; and
utilize data from the personalized channel associated with the other user to determine at least one of the one or more options.

9. The decision system of claim 8, wherein the other user comprises at least one of a trusted friend, a family member, a business associate, and an expert.

10. A method comprising:
receiving data at a decision system through a network from a computing device, the data defining a personalized channel associated with a user;
storing the personalized channel in a database including a plurality of personalized channels;
automatically determining values and attributes associated with content of the personalized channel using the decision system;
determining one or more options of interest to the user based on the determined values and attributes using the decision system; and
selectively adding data related to the one or more options to the personalized channel.

11. The method of claim 10, wherein selectively adding the data includes:
automatically adding a recommendation including data related to the one or more options to a graphical interface;
sending the graphical interface to the computing device of the user; and
adding the data to the personalized channel in response to receiving input corresponding to the graphical interface from the computing device.

12. The method of claim 10, wherein selectively adding the data includes:
determining user preferences associated with the channel; and
adding the data to the personalized channel automatically when the user preferences enable the decision system to update the channel.

13. The method of claim 10, further comprising selectively sharing the channel with one or more other users.

14. The method of claim 13, further comprising rewarding the user when another user selects a purchase option based on the sharing of the personalized channel.

15. The method of claim 10, further comprising:
receiving a search request from the computing device;
determining a plurality of options corresponding to the search request; and
automatically determining which of the plurality of options to provide to a graphical interface for transmission to the computing device based on the values and attributes associated with content of the personalized channel.

16. The method of claim 10, further comprising:
presenting a shared channel to the user via a graphical interface; and
adding a selected element from the shared channel to the personalized channel in response to a user input.

17. A decision system comprises:
an interface configured to couple to a network;
a processor coupled to the interface; and
a memory coupled to the processor, the memory configured to store instructions that, when executed, cause the processor to:
receive a user request indicating an item of interest for a user;
retrieve a personalized channel associated with the user from a database including a plurality of personalized channels;
determine a plurality of purchase options based on the user request;
prioritize the plurality of purchase options based on preferences determined from the personalized channel; and
provide an interface including data related to at least one of the plurality of purchase options to a device associated with the user.

18. The decision system of claim 17, wherein the memory further includes instructions that, when executed, cause the processor to:
receive data indicating interests of a user;
create a personalized channel associated with the user based on the received data; and
store the personalized channel in the database including the plurality of personalized channels, the personalized channel including an identifier associated with the user.

19. The decision system of claim 17, wherein the memory further includes instructions that, when executed, cause the processor to selectively share the personalized channel with one or more other users based on a preference specified by the user.

20. The decision system of claim 17, wherein the personalized channel comprises at least one of an image, a document, a paragraph of text, a video, and a link to a website.
